(19) United States
(12) Patent Application Publication
(10) Pub. No.: US 2021/0326836 A1
(43) Pub. Date: Oct. 21, 2021

(54) COMPUTERIZED PAYMENTS FOR TRANSACTION AUTHORIZATION

(71) Applicant: Wells fargo Bank, N.A., San Francisco, CA (US)

(72) Inventors: Carrie Anne Hanson, Charlotte, NC (US); Frank A. DiGangi, Statesville, NC (US); Loftlon Lindsey Worth, Huntersville, NC (US); Daniel Alexander David, Charlotte, NC (US)

(21) Appl. No.: 16/853,234

(22) Filed: Apr. 20, 2020

(51) Int. Cl. G06Q 20/32; G06Q 20/40; G06Q 20/10; G06Q 40/02

(52) U.S. Cl. CPC G06Q 20/3224; G06Q 20/4015; G06Q 40/02; G06Q 20/108; G06Q 20/3223

(57) ABSTRACT

Various examples are directed to systems and methods for authorizing a human user to execute transaction at a physical location. A location computing system may receive payment receipt data comprising an indication of a payment made from an account associated with a transaction party to an account associated with the location, and token data associated with the transaction. Based at least in part on the payment receipt data, the location computing system may determine to authorize execution of the transaction with a human user physically present at the location and generate an authorization output indicating that execution of the transaction with the human user is authorized.

### TECHNICAL FIELD

Embodiments described herein generally relate to computerized systems and methods for authorizing a human user to execute a transaction at a physical location.

### BACKGROUND

In various kinds of transactions, including in-person transactions, it is desirable to determine that a person who attempts to execute the transaction is actually a participant in the transaction or is authorized to act on behalf of a participant as a proxy.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment for authorizing a human user to execute a transaction at a location using payments.

FIG. 2 is a diagram showing another example of the environment of FIG. 1 including additional details.

FIG. 3 is a swim lane diagram showing one example of a process for sending a payment from an account associated with the user to an account associated with the location.

FIG. 4 is a swim lane diagram showing one example of a process for sending a payment from an account associated with the location to an account associated with the user.

FIG. 5 is a flowchart showing one example of a process flow that may be performed in the example environment of FIG. 1 to authorize the human user for a transaction at a physical location.

FIG. 6 is a flowchart showing one example of a process flow that may be performed in the example environment of FIG. 1 to authorize the human user for a transaction at a location as proxy for a transaction party.

FIG. 7 is a flowchart showing another example of a process flow that may be performed in the example environment of FIG. 1 to authorize the human user for a transaction at a location as proxy for a transaction party.

FIG. 8 is a flowchart showing one example of a process flow that may be performed in the example environment of FIG. 1 to authorize the human user for a transaction at a location as proxy for a transaction party.

FIG. 9 is a block diagram showing an example architecture of a user computing device.

FIG. 10 is a block diagram showing one example of a software architecture for a computing device.

FIG. 11 is a block diagram illustrating a computing device hardware architecture, within which a set or sequence of instructions can be executed to cause a machine to perform examples of any one of the methodologies discussed herein.

### DETAILED DESCRIPTION

Various examples are directed to systems and methods for authorizing a human user to execute a transaction at a physical location.

Human users often travel to physical locations, such as a financial institution branch, a real estate office, etc., to execute transactions including, for example, opening savings or checking accounts, applying for a loan, etc. When a human user is present at a physical location to execute a transaction, it is desirable to verify that the human user is authorized to execute the transaction. When the human user is a party to the transaction (referred to herein as a transaction party), verifying that the human user is authorized can include verifying the identity of the human user (i.e., that the human user actually is the transaction party that he or she claims to be). When the human user is acting as a proxy for a transaction party, verifying the human user's authorization can include verifying that the transaction party has authorized the human user to execute the transaction on behalf of the transaction party.

Consider an example in which a human user is present at a branch office of a financial institution to execute a transaction such as, for example, to make a withdrawal from an account, to access a safe-deposit box, etc. In this example, the transaction party is the owner of the safe-deposit box or account. If the human user purports to be the transaction party, then it is desirable to verify the human user's identity. If the human user claims to be acting as a proxy for the transaction party, then it is desirable to ensure that the owner has actually authorized the human user to execute the transaction on his or her behalf.

Consider another example in which a financial institution holds a business account that requires multiple individuals to authorize a transaction. In this example, the transaction parties are the individuals who must authorize a transaction. Requiring multiple parties to authorize a transaction can create considerable inconvenience if it requires the parties to be physically present at the same location or to each sign an authorization. It may be desirable to permit a human user to act as a proxy for one or more of the transaction parties (e.g., the authorized signers). When a human user acts as a proxy for one or more of the authorized signers, however, it is also desirable to ensure that the authorized signer has actually authorized the proxy.

Consider yet another example in which an individual co-signs a loan for another party. In this example, the co-signer is a transaction party. Traditionally, the co-signing individual attends the closing and/or otherwise signs the closing papers. It may be desirable, however, to simplify the process by allowing the borrower or another party to act as a proxy for the co-signer. When this occurs, however, it is also desirable to verify that the co-signer has actually authorized the proxy.

In these and other similar examples, a human user is present at a physical location to execute a transaction and it is desirable to verify that the human user is authorized to execute the transaction. In examples where the human user is a transaction party, it is desirable to verify the human user's identity. In examples where the human user is acting as a proxy for a transaction party, it is desirable to verify that the transaction party has authorized the proxy.

Various examples described herein address these and other challenges utilizing a payment network. The payment network allows parties to clear transactions between financial accounts and pass message data between the parties to the payment. For example, a first party may make a payment request. The payment request is originated using a user computing device and is directed to a financial institution computing system associated with the first party. The payment request comprises payment data describing the requested payment and may also include message data. The payment data can describe, for example, a source account from which the payment will be made (e.g., a financial account of the first party), an amount of the payment, and a destination account to which the payment will be made (e.g., a financial account of a second party). The message data can include any suitable data such as, for example, data describing the transaction.

At a location hosting a transaction, a location computing system can utilize payments executed via the payment network to authenticate a human user at the location, for example, to determine that the human user is a transaction party and/or is authorized as a proxy of the transaction party. The transaction party may send payment request data to a financial institution computing system. The payment request data can include an indication of a payment from an account of the transaction party to an account associated with the location. The payment can be for a small amount, such as for a few pennies or a fraction of a penny. The transaction party's financial institution system uses the payment request data to initiate the payment using the payment network.

When the payment network completes the payment, payment receipt data is provided, for example, to a financial institution computing system associated with the location account. The financial institution computing system associated with the location account provides payment receipt data to the location computing system. The payment receipt data describes the payment, including a description of the transaction party's account. The payment receipt data can also include token data describing the transaction and can, for example, be from and/or derived from data included with the payment request made by the transaction party. For example, the token data may be all or part of message data provided with the payment instruction.

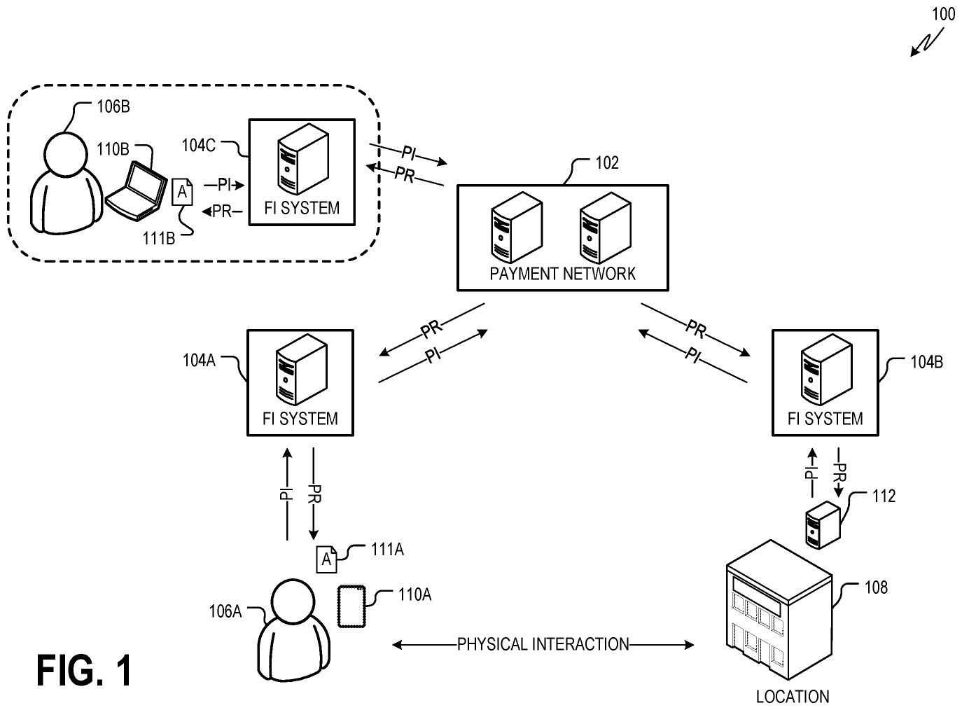

FIG. 1 is a diagram showing one example of an environment 100 for authorizing a human user to execute a transaction at a location using payments. The environment 100 includes a payment network 102, a location 108, and users 106A, 106B. The users 106A, 106B include a human user 106A who is physically present at the location 108. The location 108 is any suitable geographical location and/or facility where a user would come to execute a transaction. For example, the location 108 may be a branch of a financial institution, a real estate office, an attorney's office, etc.

The payment network 102 includes one or more computing devices that may be at a common geographic location or may be distributed across multiple geographic locations. The payment network 102 is configured to clear payments between a payee party and a payor party. For example, the payment network 102 may clear payments from a financial account associated with a payor party to a financial account associated with a payee party.

The payment network 102 may receive payment instruction data (PI in FIG. 1) from payor parties. Payment instruction data identifies the payment to be made including, for example, an amount of the payment, an account of the payor party, and an account of the payee party. Upon clearing the payment, the payment network 102 sends payment receipt data (PR in FIG. 1) to the payee party. The payment receipt data includes a description of the completed payment, including the amount of the payment, the account of the payor party, the account of the payee party.

In some examples, the payment network 102 can accept a payment request from a potential payee. The payment request can include a description of a requested payment including, for example, a payee account to receive the payment and an amount of the payment. The payment request is provided to the potential payor.

The payment network 102, in some examples, is also configured to pass message data along with payments. For example, payment instruction data may include message data from the payor party, where the message data can be any suitable data (e.g., data less than a threshold size). The payment network 102 is configured to include the message data in the payment receipt data. In this way, a payor can make a payment to the payee and also pass message data to the payee. Also, a payment request may include message data that is passed to the potential payor. The capability of the payment network 102 to pass message data may be used, as described herein, to pass token data and/or token comparison data as described herein.

In some examples, the payment network 102 is configured to clear payments quickly, for example, within fifteen minutes, within 10 minutes, within one minute, within 30 seconds. Clearing payments quickly may facilitate the use of the payment network to authorize the human user 106A, for example, because it may reduce the time to complete a transaction, quick-cleared payments may be used in real-time or near real-time to verify the identity of the users 106A, 106B, as described herein.

Examples of payment networks that may be suitable for use as the payment network 102 include the RTP network available from The Clearing House, the FedNow service from the Federal Reserve, the Zelle network by Early Warning Services, LLC, and other suitable services.

In some examples, the payment network 102 communicates with users 106A, 106B via financial institution systems 104A, 104B, 104C. Financial institution systems 104A, 104B, 104C may be maintained by financial institutions, such as financial institutions that offer accounts such as, for example, savings accounts, checking accounts, credit accounts, etc. The financial institution systems 104A, 104B, 104C may be programmed to execute transactions on one or more accounts for the respective users 106A, 106B, and/or the location 108 as described herein. In the example of FIG. 1, the user 106A utilizes a financial institution system 104A, the user 106B utilizes a financial institution system 104C and the location 108 utilizes a financial institution system 104B. In practice, however, one or more of the users 106A, 106B or the location 108 may utilize a common financial institution. Accordingly, in some examples, more than one or even all of the users 106A, 106B and the location may utilize the same financial institution system.

The users 106A, 106B also utilize user computing devices 110A, 110B. The user computing devices 106A, 106B may be or include any suitable computing device or devices such as, for example, a smart phone, a tablet computer, a laptop computer, a smart watch, etc. User computing devices execute interface applications 111A, 111B that interface between the user computing devices 110A, 110B and respective financial institution systems 104A, 104B, 104C. The interface applications 111A, 111B may be or include any suitable type of application. In some examples, the interface applications 111A, 111B are or include a banking application, mobile banking application, or mobile wallet application that is configured to allow the users 106A, 106B to make payments to merchants, or other payors, and/or receive payments. In other examples, the interface applications 111A, 111B are or include features for online banking including, for example, account balance reports, account transfers, payments, etc.

The interface applications 111A, 111B, in some examples, are authenticated to the financial institution systems 104A, 104B, 104C. For example, the users 106A, 106B may provide multi-factor authentication such as, for example, a username, a password, a one-time password (OTP) or other suitable authentication. Authentication between the interface applications 111A, 111B and the financial institution systems 104A, 104B, 104C is implemented by the financial institution systems 104A, 104B, 104C to ensure that account transactions requested through the interface applications 111A, 111B are initiated by a party authorized to make such transactions (e.g., the users 106A, 106B).

In various examples, the users 106A, 106B access the payment network 102 via the respective financial institution computing systems 104A, 104B, 104C. For example, a user 106A, 106B may generate payment instruction data and/or payment request through the interface application 111A, 111B. The interface app 111A, 111B provides the payment instruction and/or payment request to the respective financial institution system 104A, 104B, 104C. In this way, the authentication performed by the financial institution systems 104A, 104B, 104C is also relied upon by the payment network 102.

For payment instruction data, the payment network 102 clears the instructed payment and provides payment receipt data to the financial institution 104A, 104B, 104C associated with the payee account. The financial institution system 104A, 104B, 104C may provide the payment receipt data to the payee user 106A, 106B, for example, via the interface application 111A, 111B executing at the user's user computing device 110A, 110B.

For a payment request, the financial institution system 104A, 104B, 104C provides the payment request to the payment network 102 for clearing. The payment network 102 may forward payment requests to the financial institution system 104A, 104B, 104C associated with the proposed payor account. The financial institution system 104A, 104B, 104C, in turn, forwards the payment request to the user 106A, 106B who is the owner of the account, for example, via an interface application 111A, 111B.

The location 108 includes a location computing system 112. The location computing system 112 interfaces the location 108 to a financial institution system 104B that is associated with at least one account for the location 108. For example, where the location 108 is a financial institution branch, the location computing system 112 may provide an interface between the location 108 (e.g., employees of the branch) and a financial institution system 104B. The location computing system 112 may send payment requests and payment instructions to the financial institution system 104B and may receive payment receipt data from the financial institution system 104B, for example, as described herein.

In FIG. 1, the human user 106A physically interacts with the location 108. For example, the human user 106A may travel to the location 108 to execute a transaction by performing a physical activity (e.g., signing a document, accessing a safe deposit box, withdrawing money, etc.). As discussed herein, the transaction may include a transaction that does not itself include the transfer of funds, and is primarily non-financial in nature. That is, the transaction may include a transaction for opening a new financial account, a transaction for accessing safe deposit box, or a transaction to receive insurance, a loan, or financial advising, to name a few examples. The location 108, including the location computing system 112, utilizes payments (e.g., a transfer of funds) as described herein to determine whether the human user 106A is authorized to execute the transaction.

Consider various examples in which the human user 106A is also a transaction party. In one example, the human user 106A is the owner of a safe deposit box and travels to the location 108 to physically access the safe deposit box. In another example, the human user 106A is the owner of an account and travels to the location 108 to make a cash withdrawal. In yet another example, the human user 106A desires to open an account and travels to the location 108 to sign documents for opening the account.

The human user 106A, upon arriving at the location 108, may be provided with location account data describing an account associated with the location 108. For example, the location account may hold funds associated with the account and/or may be held for any other suitable purpose. The location account data can be provided to the human user 106A in any suitable manner. In some examples, the location includes a printout of a bar code, Quick Response (QR) code or other suitable graphically encoded data. The human user 106A captures a picture of the graphically encoded data, for example, using the user computing device 110A. The user computing device 110A may decode the graphically encoded data to receive the location account data. In another example, the location 108 provides a universal resource locator (URL) or other link that can be accessed using the user computing device 110A to access the location account data.

The human user 106A uses the user computing device 110A and interface application 111A to generate payment instruction data (shown as PI in FIG. 1) that is provided to the financial institution system 104A. In this example, a financial institution implementing the financial institution system 104A also administers an account associated with the human user 106A. The payment instruction data describes a payment to be made from an account associated with the human user 106A to the location account indicated by the location account data. The payment instruction may also include token data describing the desired transaction.

The financial institution system 104A sends a corresponding payment instruction to the payment network 102. The payment network 102 clears the payment and provides payment receipt data to the financial institution 104B that administers the location account. The payment receipt data indicates the cleared payment and also includes the token data. The financial institution system 104B sends a corresponding payment receipt data to the location computing system 112. Based on the payment receipt data, the location computing system 112 determines whether the human user 106A is authorized to execute the desired transaction.

For example, the location computing system 112 may be aware of one or more financial accounts held by the transaction party (e.g., the owner of the safe deposit box, account to be withdrawn, etc.). The location computing device 112 determines whether the payment was received from an account known to be held by the transaction party. If the human user 106A is able to initiate a transaction from an account known to be held by the transaction party, the location computing system 112 may conclude that the human user 106A is the transaction party and may, therefore, authorize the human user 106A to execute the transaction. For example, if the human user 106A is able to pass the authentication with the financial institution system 104A to use the interface application 111A to initiate a payment from an account, it provides a good indication that the user 106A is, in fact, the owner of the account.

Consider also various examples in which the human user 106A is acting as a proxy for a transaction party. For example, the user 106B may be the transaction party. In one example arrangement, the user 106B (the transaction party) provides the human user 106A with a passcode or other token data. Upon arriving at the location 108, the human user 106A provides the token data to the location 108. The human user 106A can provide the token data to the location 108 in any suitable manner. In some examples, the human user 106A is provided with access to an input device of the location computing system 112 and provides the token data, for example, via a keypad, microphone, or other suitable input. In other examples, the human user 106A brings the token data on a Universal Serial Bus (USB) drive or other portable data storage device. The portable data storage device is provided to the location computing system 112 and/or to associates at the location 108 who provide the portable storage device to the location computing system 112. In some examples, the human user 106A provides a payment to the account of the location 108, as described herein, and provides the token data as message data associated with the payment.

The transaction party (user 106B in this example) provides payment instruction data (PI in FIG. 1) to the financial institution system 104C via the interface application 111A. The payment instruction data can describe a payment from an account associated with the transaction party and an account associated with the location. The payment instruction data may also include token comparison data that can be compared with the token data provided to the human user 106A. In some examples, the token comparison data is equivalent to the token data. In other examples, the token comparison data can be derived from the token data and/or the token data can be derived from the token comparison data. For example, the token data may be a hash of token comparison data and/or the token comparison data may be a hash of the token data.

The financial institution system 104A receives the payment instruction data from the transaction party (user 106B in this example) and sends corresponding payment instruction data to the payment network 102. The payment network 102 clears the described payment and provides payment receipt data to the financial institution system 104B associated with the location 108. The financial institution system 104B provides corresponding payment receipt data to the location computing system 112. The payment receipt data received by the location computing system 112 includes the token comparison data. The location computing system 112 compares the token comparison data to the token data received from the human user 106A. If there is a match, then the location computing system 112 may authorize the human user 106A to execute the transaction as a proxy on behalf of the transaction party (user 106B in this example).

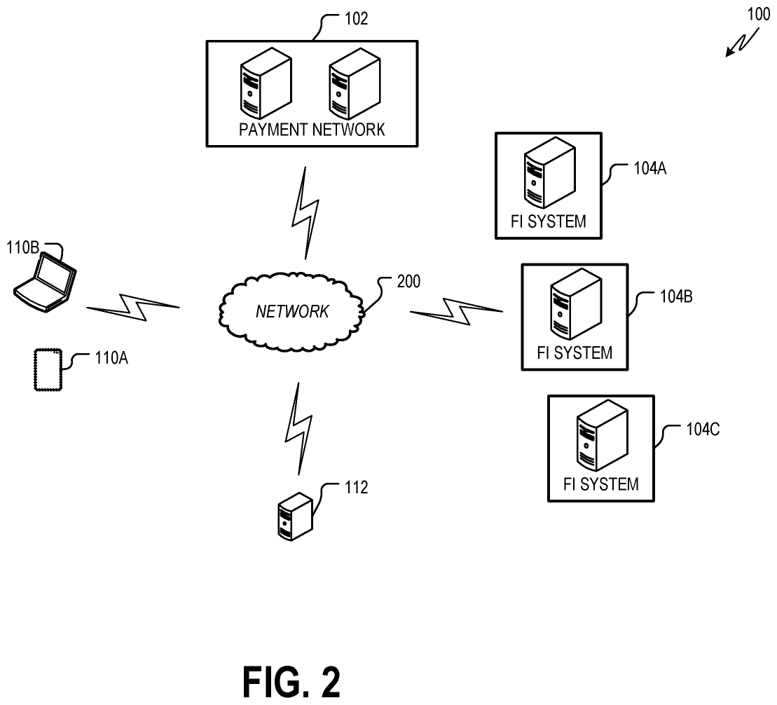

FIG. 2 is a diagram showing another example of the environment 100 including additional details. In the example of FIG. 2, the user computing devices 110A, 110B, financial institution systems 104A, 104B, 104C, location computing system 112, and payment network 102 are in communication with one another via a network 200. The network 200 may be or comprise any suitable network element operated according to any suitable network protocol. For example, one or more portions of the network 200 may be an ad hoc network, an intranet, an extranet, a virtual private network (VPN), a local-area network (LAN), a wireless LAN (WLAN), a wide-area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, another type of network, or a combination of two or more such networks.

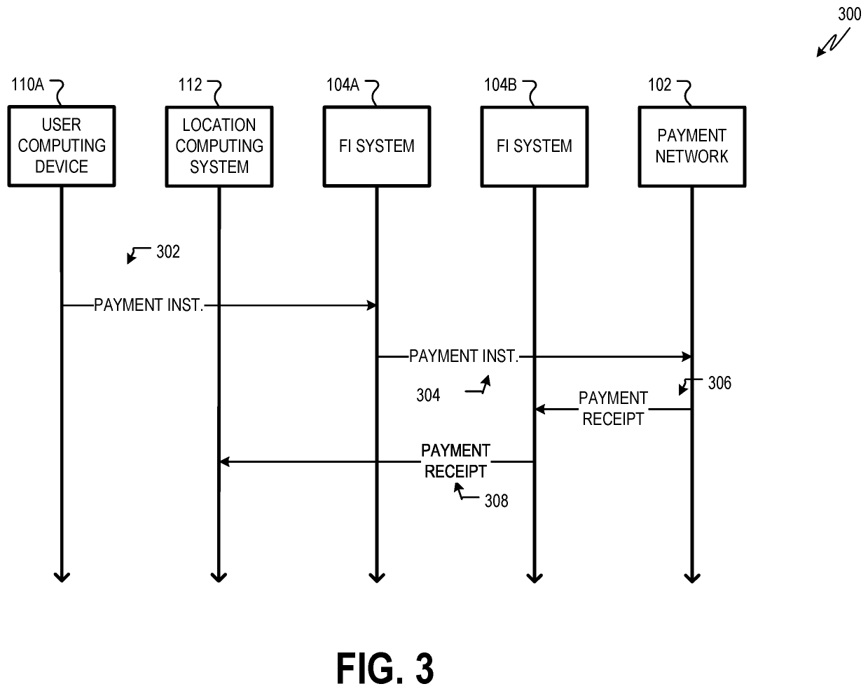

FIG. 3 is a swim lane diagram showing one example of a process 300 for sending a payment from an account associated with the user 106A to an account associated with the location 108. It will be appreciated that a similar arrangement can be used to send a payment from an account associated with the user 106B to the account associated with the location.

The user 106A, using the user computing device 110A and interface application 111A, provides payment instruction 302 data to the financial institution 104A. The payment instruction data 302 includes a description of the requested payment including, for example, an indication of a payor account associated with the user 106A, an indication of a payee account associated with the location 108, and an amount of the transaction. The payment instruction data 302 may also include token data and/or token comparison data, as described herein. The financial institution system 104A sends corresponding payment instruction data 304 to the payment network 102.

The payment network 102 clears the payment and then sends payment receipt data 306 to the financial institution system 104B associated with the location 108. The payment receipt data 306 may include data describing the payor account associated with the user 106A, the payee account associated with the location 108, and the amount of the payment. The payment receipt data 306 may also include token data and/or token comparison data, as described herein. The financial institution system 104B sends a corresponding payment receipt 308 to the location computing system 112, which may utilize the payment receipt, token data, and/or token comparison data as described herein.

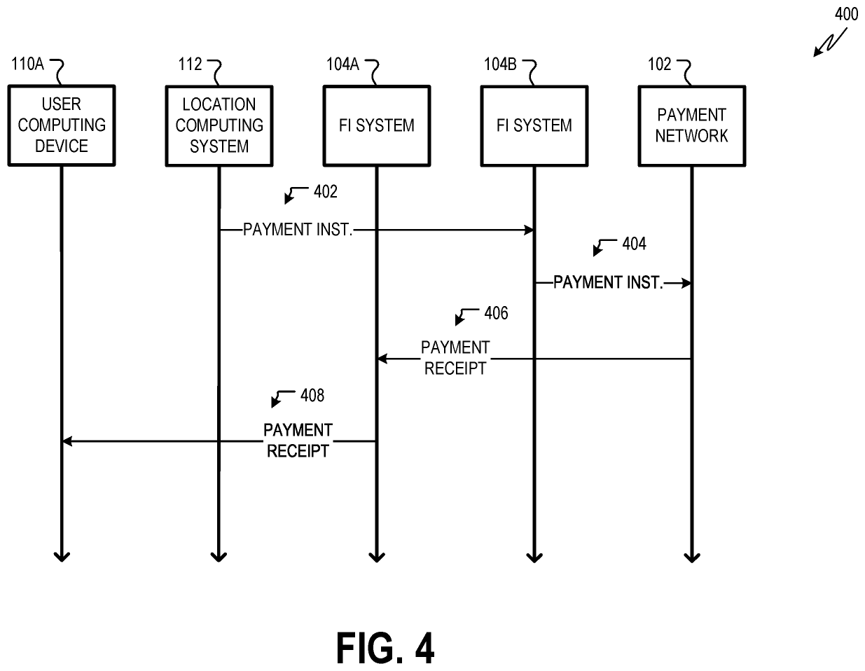

FIG. 4 is a swim lane diagram showing one example of a process 400 for sending a payment from an account associated with the location 108 to an account associated with the user 106A. It will be appreciated that a similar arrangement can be used to send a payment from the account associated with the location 108 to an account associated with the user 106B.

The location computing system 112 provides payment instruction data 402 to the financial institution 104B. The payment instruction data 402 includes a description of the requested payment including, for example, an indication of a payor account associated with the location 108, an indication of a payee account associated with the user 106A, and an amount of the transaction. The payment instruction data 402 may also include message data such as, for example, data identifying a purported proxy human user, a request to provide token data and/or token comparison data, and/or other data as described herein. The financial institution system 104B sends corresponding payment instruction data 404 to the payment network 102.

The payment network 102 clears the payment and then sends payment receipt data 406 to the financial institution system 104A associated with the user 106A. The payment receipt 406 may include data describing the payor account associated with the location 108, the payee account associated with the user 106A, and the amount of the payment. The payment receipt 406 may also include token data, token comparison data, an indication of a purported proxy human user, a request to provide token data or token comparison data, and/or other data as described herein. The user 106A may utilize the received data as described herein.

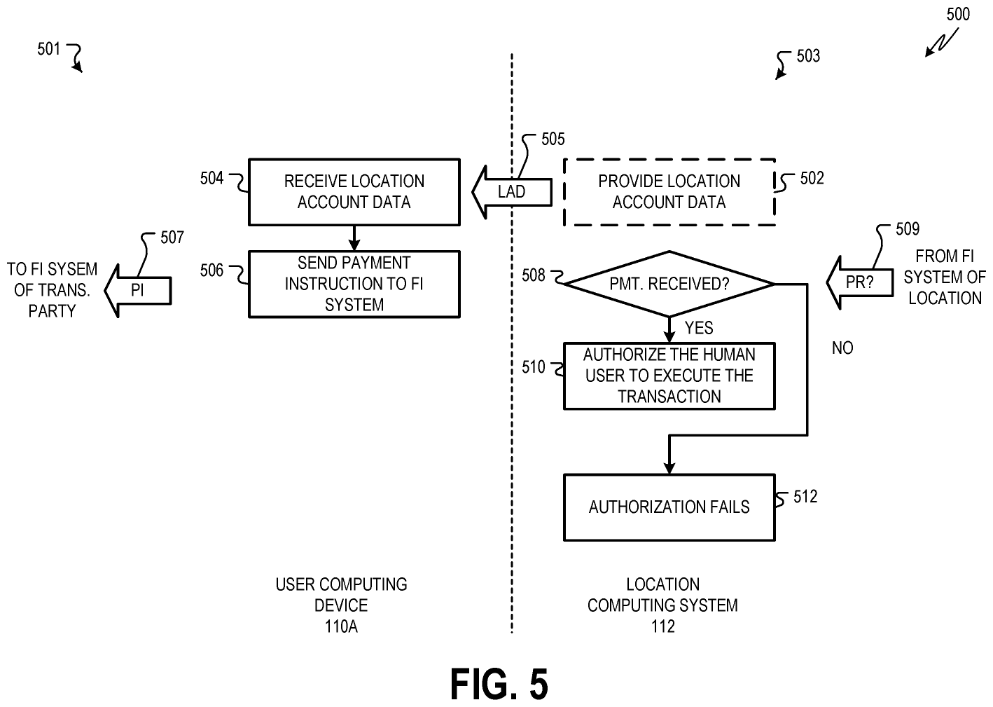

FIG. 5 is a flowchart showing one example of a process flow 500 that may be performed in the example environment 100 to authorize the human user 106A for a transaction at the location 108. The flowchart of FIG. 5 includes two columns 501, 503. Column 501 shows operations that are performed by the user computing device 110A of the human user 106A. Column 503 shows operations that are performed by the location computing system 112 of the location 108. In the example of FIG. 5, the human user 106A is a transaction party.

At optional operation 502, the location computing system 112 provides location account data 505 to the user computing device 110A, which receives the location account data 505 at operation 504. The user computing device 110A receives the location account data at operation 506. The location account data describes an account associated with the location. The location computing system 112 can provide the location account data in any suitable manner including, for example, via a short range wireless communication medium such as a Near Field Communication (NFC) protocol, an infrared communication medium, a Bluetooth or Bluetooth LE communication protocol, etc. In another example, the location computing system 112 may generate a display showing a bar code, QR code, or other suitable graphical encoding of the location account data. The user computing device 110A may capture an image of the graphical encoding and decode the depicted graphical encoding to determine the location account data. Generating a display of the graphical encoding can include displaying the graphical encoding on a screen, printing the graphical encoding on a paper or other medium, or any other suitable method.

In some examples, the operation 502 is omitted. For example, the human user 106A may already know the location account data and/or the user computing device 110A may already store the location account data. Also, in some examples, the location 108 may have a graphical encoding or other indication of the location account data printed or otherwise present at the location. Also, in some examples, a representative of the location 108 may verbally communicate the location account data to the human user 106A who may, in turn, enter the location account data into the user computing device 110A.

At operation 506, the user computing device 110A sends payment instruction data 507 to the financial institution system 104A. The payment instruction data 507 originates a payment from an account associated with the human user 106A to an account associated with the location 108. As described herein, the account associated with the human user 106A may be known to the location 108 and, therefore, the ability of the human user 106A to initiate a payment from that account may serve to authenticate the identity of the human user 106A.

The payment instruction data 507 can include an indication of a payor account associated with the human user 106A, an indication of the payee account, which is the account indicated by the location account data, and an amount. The payment instruction data 507 can also include token data that is associated with the transaction. The token data can include, for example, a description of the transaction, a description of the human user 106A, or any other suitable data. The token data may be encoded in or otherwise included in the message payment instruction data 507.

The payment instruction data 507 may be processed, for example, as described herein at the process flow 300 of FIG. 3. As shown in FIG. 3, the location computing system 112 receives a payment receipt data 509 if the payment is successfully cleared. At operation 508, the location computing system 112 determines whether it has received the payment receipt data 509. If the location computing system 112 has received the payment receipt data 509, then the location computing system 112 generates an authorization output indicating that the human user 106A is authorized to execute the transaction at operation 510. If the location computing system 112 does not receive the payment receipt data 509, it generates an indication that the authorization of the human user 106A has failed at operation 512.

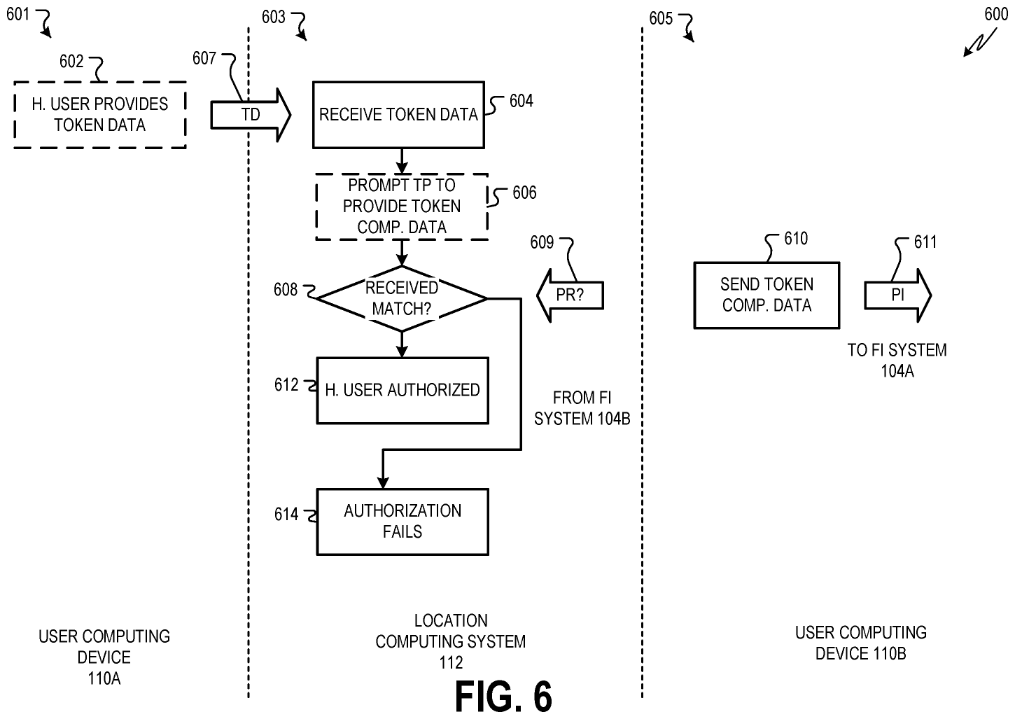

FIG. 6 is a flowchart showing one example of a process flow 600 that may be performed in the example environment 100 to authorize the human user 106A for a transaction at the location 108 as proxy for the user 106B (the transaction party). The flowchart of FIG. 6 includes three columns 601, 603, 605. Column 601 shows operations that are performed by the user computing device 110A of the human user 106A. Column 603 shows operations that are performed by the location computing system 112 of the location 108. Column 605 shows operations that are performed by the user computing device 110B of the user 106B. In the example of FIG. 6, the user 106B is the transaction party and the human user 106A acts as a proxy for the user 106B (the transaction party).

In the process flow 600, the user 106B (the transaction party) provides the human user 106A with token data indicating that the human user 106A is authorized to execute a transaction on behalf of the user 106B. The user 106B (the transaction party) also provides token comparison data to the location computing system 112. The location computing system 112 determines whether to authorize the human user 106A to execute the transaction as a proxy for the user 106B if there is a match between the token data and the token comparison data.

At optional operation 602, the user computing device 110A provides token data 607 to the location computing system 112. The token data 607 is received from the user 106B (the transaction party). For example, the user 106B (the transaction party) may provide the token data 607 to the human user 106A and/or the associated user computing device 110A verbally and/or by any other suitable method. The user computing device 110A provides the token data 607 to the location computing system 112 in any suitable manner including, for example, via a short range wireless communication medium, etc.

In some examples, the operation 602 is performed by the human user 106A without the assistance of the user computing device 110A. For example, the human user 106A may enter the token data 607 into an input device of the location computing system 112 and/or verbally relate the token data 607 to an associate at the location 108 who, in turn, enters the token data 607 into the location computing system. In another example, the human user 106A provides a card or other printed object including a graphical representation of the token data 607. An image sensor or similar input device of the location computing system 112 is used to capture an image of the printed object from which the location computing system 112 extracts the token data 607. At operation 604, the location computing system 112 receives the token data from the user computing device 110A (and/or from the human user 106A).

At optional operation 606, the location computing system 112 prompts the user 106B (the transaction party) to provide token comparison data. For example, the location computing system 112 may send payment instruction data and/or payment request data to the financial institution system 104B including request data requesting that the transaction party provide token comparison data. The user 106B (the transaction party) may respond by sending payment instruction data and/or payment request including the token comparison data at operation 610 as described herein. In some examples, the user (the transaction party) provides token comparison data without prompting and the operation 606 is omitted.

At operation 610, the user computing device 110B of the user 106B (the transaction party in this example) sends payment instruction data 611 to the financial institution system 104C. The payment instruction data 611 includes a description of a payment from an account associated with the user 106B to an account associated with the location 108. The payment instruction data 611 also includes token comparison data.

At operation 608, the location computing system 112 determines if it has received a payment receipt data 609 including token comparison data that matches the token data 607. For example, the payment receipt data 609 may be a result of the payment instruction data 611 send by the user computing device 110B at operation 610. Upon receiving the payment receipt data 609, the location computing system 112 determines if the token comparison data matches the token data, for example, as described herein. If there is a match, the location computing system 112, at operation 612, generates an authorization output indicating that the human user 106A is authorized to execute the transaction as a proxy of the user 106B (the transaction party). If there is no match or no payment receipt data 609 is received, the location computing system 112, at operation 614, generates an indication that the human user 106A is not authorized to execute the transaction as a proxy of the user 106B (the transaction party).

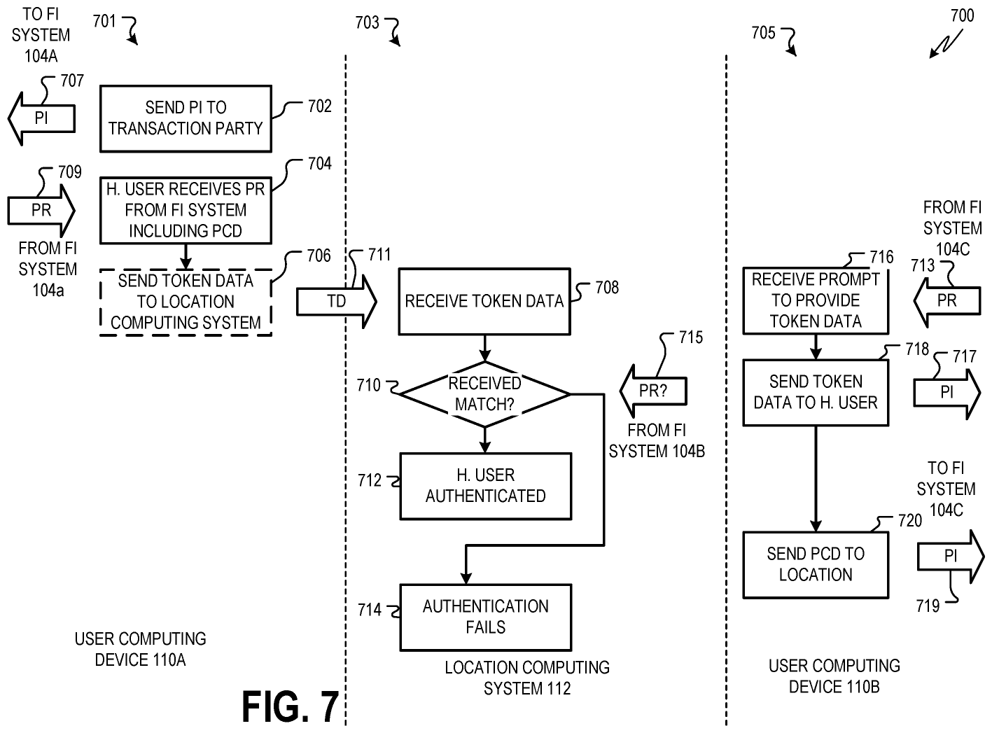

FIG. 7 is a flowchart showing one example of a process flow 700 that may be performed in the example environment 100 to authorize the human user 106A for a transaction at the location 108 as proxy for the user 106B (the transaction party). The flowchart of FIG. 7 includes three columns 701, 703, 705. Column 701 shows operations that are performed by the user computing device 110A of the human user 106A. Column 703 shows operations that are performed by the location computing system 112 of the location 108. Column 705 shows operations that are performed by the user computing device 110B of the user 106B. In the example of FIG. 7, the user 106B is the transaction party and the human user 106A acts as a proxy for the user 106B (the transaction party).

In the process flow 700, the human user 106A prompts the user 106B (the transaction party) to provide token data to the human user 106A and token comparison data to the location computing system 112. The location computing system 112 determines to authorize the human user 106A to execute the transaction on behalf of the user 106B (the transaction party) if the token data matches the token comparison data.

At operation 702, the user computing device 110A sends payment instruction data 707 to the financial institution system 104A. The payment instruction data 707 initiates a payment from an account associated with the human user 106A to the location 108 to verify the identity of the human user 106A. The payment instruction data 707 indicates a payor account associated with the human user 106A, a payee account associated with the user 106B (the transaction party), and an amount of the payment. The payment instruction data 707 may also include message data indicating a request for authorization for a transaction at the location 108.

The payment instruction data 707 results in a payment receipt data 713 provided to the user computing device 110B at operation 716. The payment receipt data 713 indicates the payor account associated with the human user 106A, the payee account associated with the user 106B (the transaction party), and an amount of the payment. The payment receipt data 713 may also include the message data indicating the request for authorization for the transaction at the location 108. The success of the payment indicated by the payment receipt data 713 may provide the user 106B (the transaction party) with verification of the identity of the human user 106A as it confirms that the human user 106A was successful in drawing on the payor account.

In response to receiving the payment receipt data 713, the user computing device 110B sends payment instruction data 717 to the financial institution system 104C. The payment instruction data 717 includes an indication of a payor account associated with the user 106B, an indication of a payee account associated with the human user 106A and an amount. The payment instruction data 717 also includes token data that the human user 106A can provide to the location 108, as described herein, to indication that the human user 106A is authorized to execute the transaction.

At operation 704, the user computing device 110A receives payment receipt data 709 resulting from the payment instruction data 717. The payment receipt data includes an indication of the payor account associated with the user 106B, an indication of the payee account associated with the human user 106A and the amount. The payment receipt data 709 also includes the token data. At optional operation 706, the user computing device 110A provides the token data 711 to the location computing system 112, for example, similar to operation 602 of the process flow 600. Also, as described with respect to the process flow 600, the human user 106A can, in some examples, provide the token data 711 to the location computing system 112 without the assistance of the user computing device 110A. The location computing system receives the token data at operation 708.

At operation 720, the user computing device 110B sends a payment instruction data 719 to the financial institution system 104C. The payment instruction data 719 includes an indication of a payor account associated with the user 106B (the transaction party), an indication of a payee account associated with the location 112, an amount of the transaction, and token comparison data. The sending of the payment instruction data 719 may be prompted by the location computing system 112, as shown in the process flow 600, and/or may be prompted by the request from the human user 106A received via the payment receipt data 713 described above.

Referring back to column 703, the location computing system 112 determines at operation 710 if it has received from the user 106B (the transaction party), token comparison data that matches the token data 711 received from the human user 106A. For example, the location computing system may receive the token comparison data via payment receipt data 715 received from the financial institution system 104B responsive to the payment instruction data 719. The payment receipt data 715 may include indication of the payor account associated with the user 106B (the transaction party), an indication of the payee account associated with the location 112, an amount of the transaction, and token comparison data.

Upon receiving the payment receipt data 709, the location computing system 112 determines if the token comparison data matches the token data, for example, as described herein. If there is a match, the location computing system 112, at operation 712, generates an authorization output indicating that the human user 106A is authorized to execute the transaction as a proxy of the user 106B (the transaction party). If there is no match or no payment receipt data 709 is received, the location computing system 112, at operation 714, generates an indication that the human user 106A is not authorized to execute the transaction as a proxy of the user 106B (the transaction party).

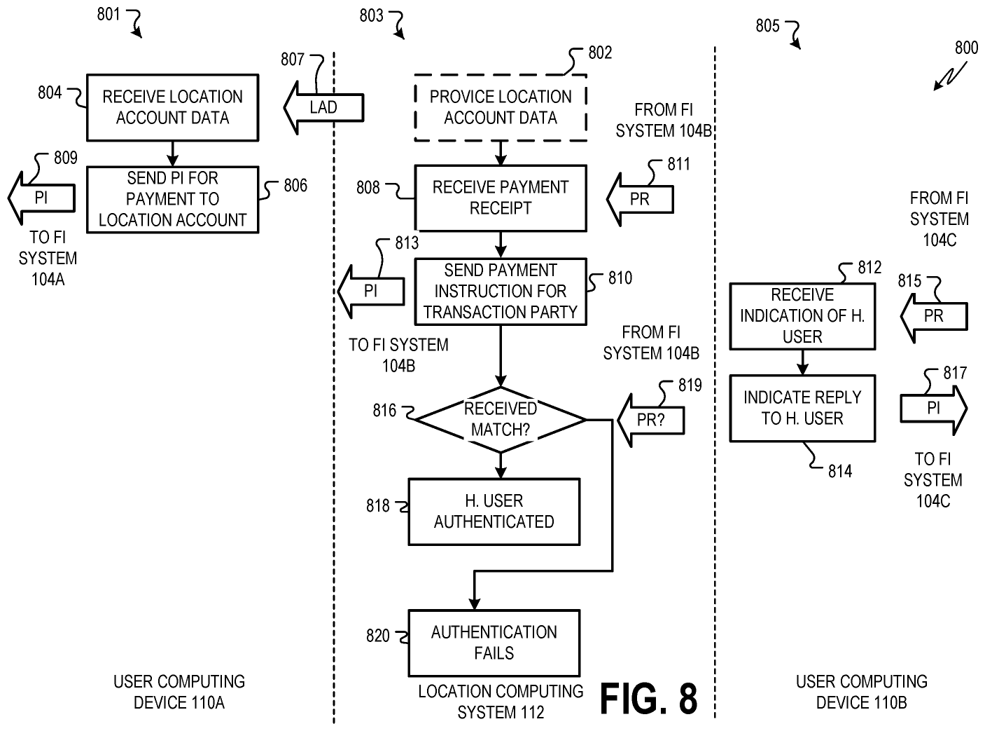

FIG. 8 is a flowchart showing one example of a process flow 800 that may be performed in the example environment 100 to authorize the human user 106A for a transaction at the location 108 as proxy for the user 106B (the transaction party). The flowchart of FIG. 8 includes three columns 801, 803, 805. Column 801 shows operations that are performed by the user computing device 110A of the human user 106A. Column 803 shows operations that are performed by the location computing system 112 of the location 108. Column 805 shows operations that are performed by the user computing device 110B of the user 106B. In the example of FIG. 8, the user 106B is the transaction party and the human user 106A acts as a proxy for the user 106B (the transaction party).

In the process flow 800, the human user 106A arrives at the location 108 and uses a payment instruction data 809 to authenticate to the location computing system 112. The location computing system 112 uses a payment instruction data 813 to request authorization from the user 106B (the transaction party) for the human user 106A to execute the transaction as a proxy for the user 106B.

At optional operation 802, the location computing system 112 provides location account data 807 to the user computing device 110A. The user computing device 110A receives the location account data at operation 804. In some examples, the operation 802 is performed in a manner similar to the operation 502 of the process flow 500. Also, in some examples, as described herein, the provision of location account data 807 to the human user 106A does not involve the location computing device 112 and/or the user computing device 110A.

At operation 806, the computing device 110A sends a payment instruction data 809 to the financial institution system 104A. The payment instruction data 809 includes an indication of a payor account associated with the human user 106A, an indication of a payee account that is the location account indicated by the location account data 807, an indication of an amount of the payment, and (optionally) token data associated with the transaction.

As a result of the payment instruction data 809, the location computing system 112 receives payment receipt data 811 from the financial institution system 104B at operation 808. The payment receipt data includes an indication of the payor account associated with the human user 106A, an indication of location account as the payee account, an indication of the amount of the payment and the optional token data. In some examples, the location computing system 112 uses the payment receipt data to identify the human user 106A. For example, the human user 106A may be the owner of the payor account.

At operation 810, the location computing device 112 sends a payment instruction data 813 to the financial institution system 104B. The payment instruction data 813 describes a payment to be cleared by the payment network 102 that is directed from the location 108 to the user 106B (the transaction party). Message data associated with the payment includes a description of the human user 106A derived from the payment receipt data 811 and a request to authorized the human user 106A to execute a transaction on behalf of the user 106B (the transaction party). The payment instruction data 813 includes an indication of a payor account associated with the location 108, a payee account associated with the user 106B (the transaction party), an amount, and the message data.

At operation 812, the user computing device 110B receives payment receipt data 815 resulting from the payment instruction data 813. Upon receiving the payment receipt data 815, the user 106B (the transaction party) may decide whether to authorize the human user 106A described by the message data to execute the transaction described by the message data on behalf of the user 106B.

The user 106B indicates whether to authorize the human user 106A to execute the transaction as proxy for the user 106B (the transaction party) by sending a payment instruction data 817 to the financial institution system 104C at operation 814. The payment instruction data 817 indicates a payor account associated with the user 106B (the transaction party), a payee account associated with the location 108, an amount of the payment, and message data indicating whether the user 106B assents to the human user 106A as proxy for the transaction.

As a result of the payment instruction data 817, the location computing system 112 receives payment receipt data 819. The payment receipt data 819 indicates the payor account associated with the user 106B (the transaction party), the payee account associated with the location 108, the amount of the payment, and the message data indicating whether the user 106B assents to the human user 106A as proxy for the transaction. At operation 816, the location computing system 112 determines whether the user 106B (the transaction party) has assented to the human user 106A as proxy. If the message data indicates assent, the location computing system 112 determines that the user 106B (the transaction party) has assented. The location computing system 112, at operation 818, generates an authorization output indicating that the human user 106A is authorized to execute the transaction as proxy for the user 106B (the transaction party). If the message data indicates a lack of assent and/or if no payment receipt data 819 is received, the location computing system 112 determines that the user 106B has not assented. The location computing device 112, at operation 820, generates an indication that the human user 106A is not authorized to execute the transaction as proxy for the user 106B (the transaction party).

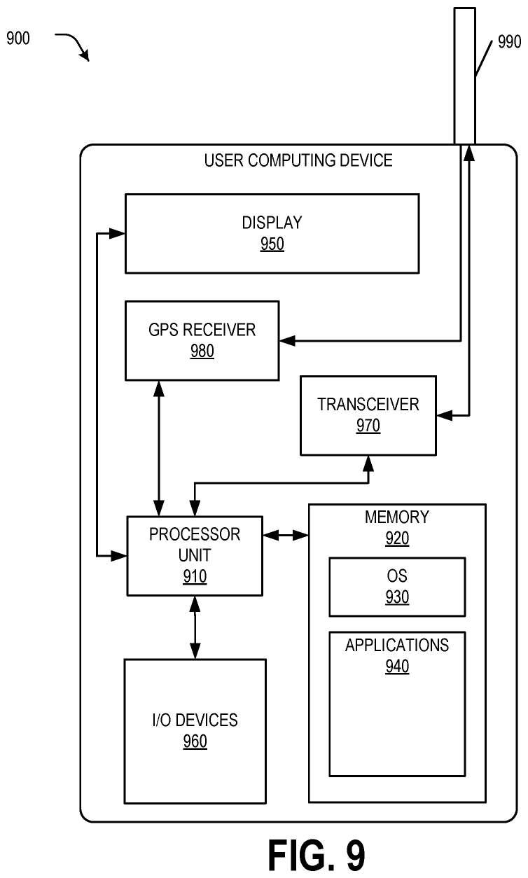

FIG. 9 is a block diagram showing an example architecture 900 of a user computing device. The architecture 900 may, for example, describe any of user computing devices 110A, 110B described herein. The architecture 900 comprises a processor unit 910. The processor unit 910 may include one or more processors. Any of a variety of different types of commercially available processors suitable for computing devices may be used (for example, an XScale architecture microprocessor, a Microprocessor without Interlocked Pipeline Stages (MIPS) architecture processor, or another type of processor). A memory 920, such as a Random Access Memory (RAM), a flash memory, or another type of memory or data storage, is typically accessible to the processor unit 910. The memory 920 may be adapted to store an operating system (OS) 930, as well as application programs 940.

The processor unit 910 may be coupled, either directly or via appropriate intermediary hardware, to a display 950 and to one or more I/O devices 960, such as a keypad, a touch panel sensor, a microphone, and the like. Such I/O devices 960 may include a touch sensor for capturing fingerprint data, a camera for capturing one or more images of the user, a retinal scanner, or any other suitable devices. The I/O devices 960 may be used to implement I/O channels. In some examples, the I/O devices 960 may also include sensors.

Similarly, in some examples, the processor unit 910 may be coupled to a transceiver 970 that interfaces with an antenna 990. The transceiver 970 may be configured to both transmit and receive cellular network signals, wireless data signals, or other types of signals via the antenna 990, depending on the nature of the computing device implemented by the architecture 900. Although one transceiver 970 is shown, in some examples, the architecture 900 includes additional transceivers. For example, a wireless transceiver may be utilized to communicate according to an IEEE 802.11 specification, such as Wi-Fi and/or a short-range communication medium. Some short-range communication mediums, such as Near Field Communication NFC, may utilize a separate, dedicated transceiver. Further, in some configurations, a Global Positioning System (GPS) receiver 980 may also make use of the antenna 990 to receive GPS signals. In addition to or instead of the GPS receiver 980, any suitable location-determining sensor may be included and/or used, including, for example, a Wi-Fi positioning system. In some examples, the architecture 900 (e.g., the processor unit 910) may also support a hardware interrupt. In response to a hardware interrupt, the processor unit 910 may pause its processing and execute an interrupt service routine (ISR).

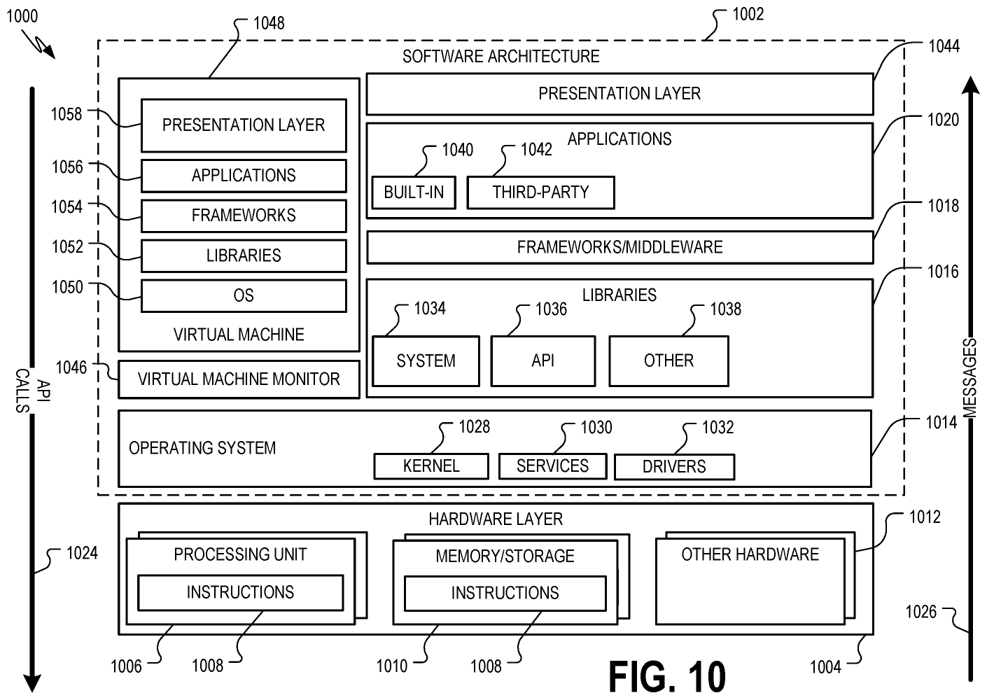

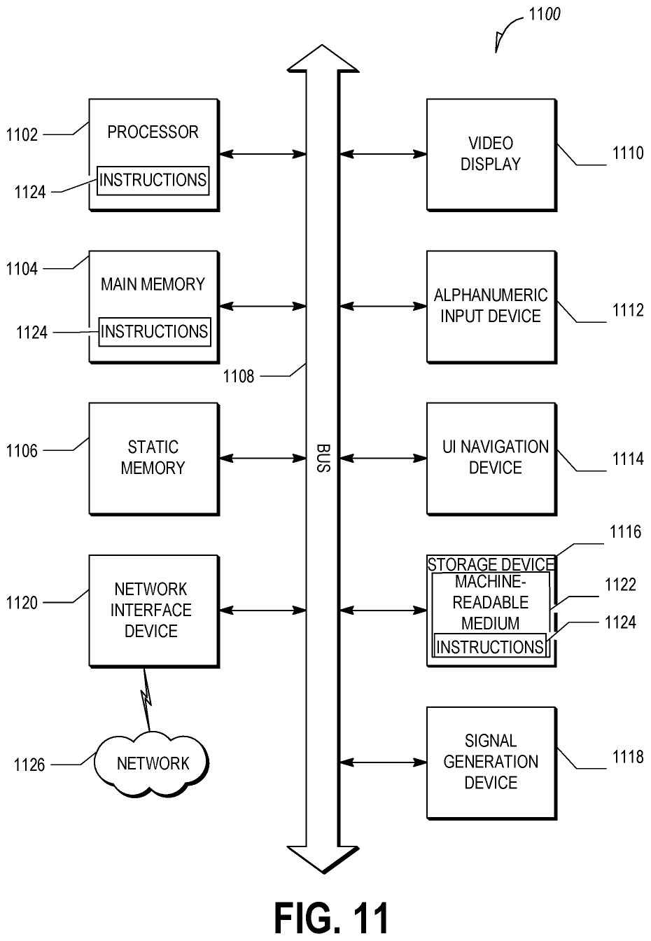

FIG. 10 is a block diagram 1000 showing one example of a software architecture 1002 for a computing device. The software architecture 1002 may be used in conjunction with various hardware architectures, for example, as described herein. FIG. 10 is merely a non-limiting example of a software architecture 1002, and many other architectures may be implemented to facilitate the functionality described herein. A representative hardware layer 1004 is illustrated and can represent, for example, any of the above-referenced computing devices. In some examples, the hardware layer 1004 may be implemented according to an architecture 1100 of FIG. 11.

The representative hardware layer 1004 comprises one or more processing units 1006 having associated executable instructions 1008. The executable instructions 1008 represent the executable instructions of the software architecture 1002, including implementation of the methods, modules, components, and so forth of FIGS. 1-8. The hardware layer 1004 also includes memory and/or storage modules 1010, which also have the executable instructions 1008. The hardware layer 1004 may also comprise other hardware 1012, which represents any other hardware of the hardware layer 1004, such as the other hardware illustrated as part of the architecture 1100.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020, and a presentation layer 1044. Operationally, the applications 1020 and/or other components within the layers may invoke application programming interface (API) calls 1024 through the software stack and receive a response, returned values, and so forth illustrated as messages 1026 in response to the API calls 1024. The layers illustrated are representative in nature and not all software architectures have all layers. For example, some mobile or special-purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of a hardware or software interrupt and, in response, cause the software architecture 1002 to pause its current processing and execute an ISR when an interrupt is received. The ISR may generate an alert.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, and/or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 and/or other software components/modules. For example, the frameworks 1018 may provide various graphical user interface (GUI) functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a contacts application, a browser application, a book reader application, a location application, a media application, a messaging application, and/or a game application. The third-party applications 1042 may include any of the built-in applications 1040 as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 1042 may invoke the API calls 1024 provided by the mobile operating system such as the operating system 1014 to facilitate functionality described herein.

The applications 1020 may utilize built-in operating system functions (e.g., kernel 1028, services 1030, and/or drivers 1032), libraries (e.g., system libraries 1034, API libraries 1036, and other libraries 1038), or frameworks/middleware 1018 to create user interfaces to interact with users of the system. Alternatively, or additionally, in some systems, interactions with a user may occur through a presentation layer, such as the presentation layer 1044. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 10, this is illustrated by a virtual machine 1048. A virtual machine creates a software environment where applications/modules can execute as if they were executing on a hardware computing device. The virtual machine 1048 is hosted by a host operating system (e.g., the operating system 1014) and typically, although not always, has a virtual machine monitor 1046, which manages the operation of the virtual machine 1048 as well as the interface with the host operating system (e.g., the operating system 1014). A software architecture executes within the virtual machine 1048, such as an operating system 1050, libraries 1052, frameworks/middleware 1054, applications 1056, and/or a presentation layer 1058. These layers of software architecture executing within the virtual machine 1048 can be the same as corresponding layers previously described or may be different.

FIG. 11 is a block diagram illustrating a computing device hardware architecture 1100, within which a set or sequence of instructions can be executed to cause a machine to perform examples of any one of the methodologies discussed herein. The architecture 1100 may describe, for example, any of the computing devices and/or control circuits described herein. The architecture 1100 may execute the software architecture 1002 described with respect to FIG. 10. The architecture 1100 may operate as a standalone device or may be connected (e.g., networked) to other machines. In a networked deployment, the architecture 1100 may operate in the capacity of either a server or a client machine in server-client network environments, or it may act as a peer machine in peer-to-peer (or distributed) network environments. The architecture 1100 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 1100 includes a processor unit 1102 comprising at least one processor (e.g., a central processing unit (CPU), a graphics processing unit (GPU), or both, processor cores, compute nodes, etc.). The architecture 1100 may further comprise a main memory 1104 and a static memory 1106, which communicate with each other via a link 1108 (e.g., a bus). The architecture 1100 can further include a video display unit 1110, an alphanumeric input device 1112 (e.g., a keyboard), and a UI navigation device 1114 (e.g., a mouse). In some examples, the video display unit 1110, alphanumeric input device 1112, and UI navigation device 1114 are incorporated into a touchscreen display. The architecture 1100 may additionally include a storage device 1116 (e.g., a drive unit), a signal generation device 1118 (e.g., a speaker), a network interface device 1120, and one or more sensors (not shown), such as a GPS sensor, compass, accelerometer, or other sensor.

In some examples, the processor unit 1102 or another suitable hardware component may support a hardware interrupt. In response to a hardware interrupt, the processor unit 1102 may pause its processing and execute an ISR, for example, as described herein.

The storage device 1116 includes a non-transitory machine-readable medium 1122 on which is stored one or more sets of data structures and instructions 1124 (e.g., software) embodying or utilized by any one or more of the methodologies or functions described herein. The instructions 1124 can also reside, completely or at least partially, within the main memory 1104, within the static memory 1106, and/or within the processor unit 1102 during execution thereof by the architecture 1100, with the main memory 1104, the static memory 1106, and the processor unit 1102 also constituting machine-readable media. The instructions 1124 stored at the machine-readable medium 1122 may include, for example, instructions for implementing the software architecture 1002, instructions for executing any of the features described herein, etc.

While the machine-readable medium 1122 is illustrated in an example to be a single medium, the term “machine-readable medium” can include a single medium or multiple media (e.g., a centralized or distributed database, and/or associated caches and servers) that store the one or more instructions 1124. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM) and electrically erasable programmable read-only memory (EEPROM)) and flash memory devices; magnetic disks such as internal hard disks and removable disks; magneto-optical disks; and CD-ROM and DVD-ROM disks.

The instructions 1124 can further be transmitted or received over a communications network 1126 using a transmission medium via the network interface device 1120 utilizing any one of a number of well-known transfer protocols (e.g., hypertext transfer protocol (HTTP)). Examples of communication networks include a LAN, a WAN, the Internet, mobile telephone networks, plain old telephone service (POTS) networks, and wireless data networks (e.g., Wi-Fi, 3G, and 5G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A computerized system for authorizing a human user to execute a transaction at a physical location, the system comprising:
a location computing system comprising at least one processor unit programmed to perform operations comprising:
receiving payment receipt data comprising:
an indication of a payment made from an account associated with a transaction party to an account associated with the location; and
token data associated with the transaction;
based at least in part on the payment receipt data, determining to authorize execution of the transaction with a human user physically present at the location; and
generating an authorization output indicating that execution of the transaction with the human user is authorized.

2. The system of claim 1, the operations further comprising providing location account data to the human user, the location account data describing the account associated with the location.

3. The system of claim 2, further comprising a user computing device associated with the human user, wherein the human user is the transaction party, and wherein the user computing device is programmed to perform operations comprising:
receiving the location account data; and
sending a payment instruction, the payment instruction describing the payment from the account associated with the transaction party to the account associated with the location.

4. The system of claim 1, the operations further comprising:
receiving token comparison data from the transaction party; and
determining, by the location computing system, that the token comparison data matches the token data.

5. The system of claim 4, the operations further comprising:
sending payment instruction data, the payment instruction data comprising:
an indication of a payment to be made from the account associated with the location to the account associated with the transaction party; and
request data requesting that the transaction party provide the token data.

6. The system of claim 4, further comprising a user computing device associated with the human user, the user computing device programmed to perform operations comprising sending payment instruction data, the payment instruction comprising:
an indication of a payment from an account associated with the human user to the account associated with the transaction party; and
request data requesting that the transaction party provide the token comparison data.

7. The system of claim 6, wherein the user computing device is further programmed to perform operations comprising receiving payment receipt data by the user computing device associated with the human user, the payment receipt data comprising:
an indication of a payment from the account associated with transaction party to the account associated with the human user; and
the token comparison data.

8. The system of claim 1, the operations further comprising:
receiving second payment receipt data comprising an indication of a payment made from an account associated with the human user to the transaction party;
based at least in part on the second payment receipt data, sending payment instruction data, the payment instruction data comprising:
an indication of a payment from the account associated with the location to the account associated with the transaction party; and
data describing the human user, the data describing the human user based at least in part on the second payment receipt data.

9. The system of claim 1, wherein the token data associated with the transaction indicates authorization of the transaction party for of the human user.

10. A computerized method of authorizing a human user for a transaction at a physical location, the method comprising:
receiving, by a location computing system, payment receipt data comprising:
an indication of a payment made from an account associated with a transaction party to an account associated with the location; and
token data associated with the transaction;
based at least in part on the payment receipt data, determining, by the location computing system, to authorize execution of the transaction with a human user physically present at the location; and
generating, by the location computing system, an authorization output indicating that execution of the transaction with the human user is authorized.

11. The method of claim 10, further comprising providing location account data to the human user, the location account data describing the account associated with the location.

12. The method of claim 11, wherein the human user is the transaction party, the method further comprising:
receiving, by a user computing device, the location account data; and
sending, by the user computing device, payment instruction data, the payment instruction describing the payment from the account associated with the transaction party to the account associated with the location.

13. The method of claim 10, further comprising:
receiving token comparison data from the transaction party; and
determining, by the location computing system, that the token comparison data matches the token data.

14. The method of claim 13, further comprising:
sending, by the location computing system, payment instruction data, the payment instruction comprising:
an indication of a payment to be made from the account associated with the location to the account associated with the transaction party; and
request data requesting that the transaction party provide the token data.

15. The method of claim 13, further comprising sending, by a user computing device associated with the human user, payment instruction data, the payment instruction comprising:
an indication of a payment from an account associated with the human user to the account associated with the transaction party; and
request data requesting that the transaction party provide the token comparison data.

16. The method of claim 15, further comprising receiving payment receipt data by the user computing device associated with the human user, the payment receipt data comprising:
an indication of a payment from the account associated with transaction party to the account associated with the human user; and
the token comparison data.

17. The method of claim 10, further comprising:
receiving, by the location computing system, second payment receipt data comprising an indication of a payment made from an account associated with the human user to the transaction party;
based at least in part on the second payment receipt data, sending payment instruction data, the payment instruction data comprising:
an indication of a payment from the account associated with the location to the account associated with the transaction party; and
data describing the human user, the data describing the human user based at least in part on the second payment receipt data.

18. The method of claim 10, wherein the token data associated with the transaction indicates authorization of the transaction party for the human user.

19. A machine-readable medium comprising instructions thereon that, when executed by at least one processor unit, causes the at least one processor unit to perform operations comprising:
receiving payment receipt data comprising:
an indication of a payment made from an account associated with a transaction party to an account associated with a location; and
token data associated with the transaction;
based at least in part on the payment receipt data, determining to authorize execution of the transaction with a human user physically present at the location; and
generating an authorization output indicating that execution of the transaction with the human user is authorized.

20. The medium of claim 19, the operations further comprising providing location account data to the human user, the location account data describing the account associated with the location.
